(19) United States
(12) Patent Application Publication
(10) Pub. No.: US 2011/0003542 A1
(43) Pub. Date: Jan. 6, 2011

(54) Roof Ventilation System

(76) Inventor: Robin Halland, West Fargo, ND (US)

Correspondence Address: NEUSTEL LAW OFFICES, LTD., 2534 SOUTH UNIVERSITY DRIVE, SUITE 4, FARGO, ND, 58103, US

(21) Appl. No.: 12/497,801

(22) Filed: Jul. 6, 2009

(51) Int. Cl. E04H 7/22

(52) U.S. Cl. 454/182

(57) ABSTRACT

A roof ventilation system for efficiently allowing air to flow through the peak of a grain bin year round. The roof ventilation system generally includes a frame extending from the upper opening, wherein the frame defines a passageway extending through an interior of the frame adapted to communicate air flow between an interior of the grain bin and ambient air. A shell at least partially surrounding the frame to at least partially seal the interior of the frame. A screen is interconnected between the frame and the shell, wherein the screen includes a plurality of outlets extending therethrough in communication with the passageway. A heating element is in communication with the screen, wherein the heating element dissipates heat to the screen to prevent ice buildup upon the screen.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a grain bin and more specifically it relates to a roof ventilation system for efficiently allowing air to flow through the peak of a grain bin year round.

2. Description of the Related Art

Any discussion of the related art throughout the specification should in no way be considered as an admission that such related art is widely known or forms part of common general knowledge in the field.

In the area of storage bins, such as grain bins, it is useful to ventilate the stored grain in order to preserve and dry the grain. The grain bins often include multiple fans or ventilation systems to circulate air through the grain and out of the bin. The fans work by drawing in ambient air and circulating the air within the grain bin through the grain to release moisture from the grain and subsequently blowing the moisture filled air out through the vents near the roof of the grain bin.

However, during periods of the year that bring freezing temperatures, the moisture released from the grain can freeze within the vents, thus blocking the air circulation through the vents. The moisture can also accumulate upon the vents via built up sweat or moisture within the grain bin due to the combination of the circulated air within the grain bin being heated and the freezing temperatures outside of the vents. Once the vents are blocked, the grain bin can easily swell or deform because of the continually built up pressure from the fans inside of the grain bin. If not caught in time, it can be very expensive to return the grain bin to a prior state.

Even if the freezing vents are caught in time, it can be very time consuming, expensive, and even dangerous to thaw the vents or remove the ice there from, wherein the operator must generally climb to the top of the grain bin to access the vents. The upper lid of the bin may be removed to allow ventilation within; however the lid must be monitored so that the lid is not left off of the bin during rain, snow or other times that can cause debris or water to enter the grain bin and contact the grain within. Because of the inherent problems with the related art, there is a need for a new and improved roof ventilation system for efficiently allowing air to flow through the peak of a grain bin year round.

### BRIEF SUMMARY OF THE INVENTION

A system for efficiently allowing air to flow through the peak of a grain bin year round. The invention generally relates to a ventilation system for a grain bin which includes a frame extending from the upper opening, wherein the frame defines a passageway extending through an interior of the frame adapted to communicate air flow between an interior of the grain bin and ambient air. A shell at least partially surrounding the frame to at least partially seal the interior of the frame. A screen is interconnected between the frame and the shell, wherein the screen includes a plurality of outlets extending therethrough in communication with the passageway. A heating element is in communication with the screen, wherein the heating element dissipates heat to the screen to prevent ice buildup upon the screen.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is a side view of the present invention installed upon a grain bin.

FIG. 3 is a side view of the present invention exploded from a grain bin.

FIG. 4 is an exploded side view of the present invention.

FIG. 5 is a side view of the present invention.

FIG. 6 is a side cross-sectional view of the present invention.

FIG. 7 is a top view of the present invention.

FIG. 8 is a top sectional view of the present invention showing the screen and the heating element interlaced around the screen.

FIG. 9 is a top sectional view of the present invention showing the screen and the heating element integral with the screen.

FIG. 10 is a top sectional view of the present invention showing the screen without a heating element.

### DETAILED DESCRIPTION OF THE INVENTION

### A. Overview

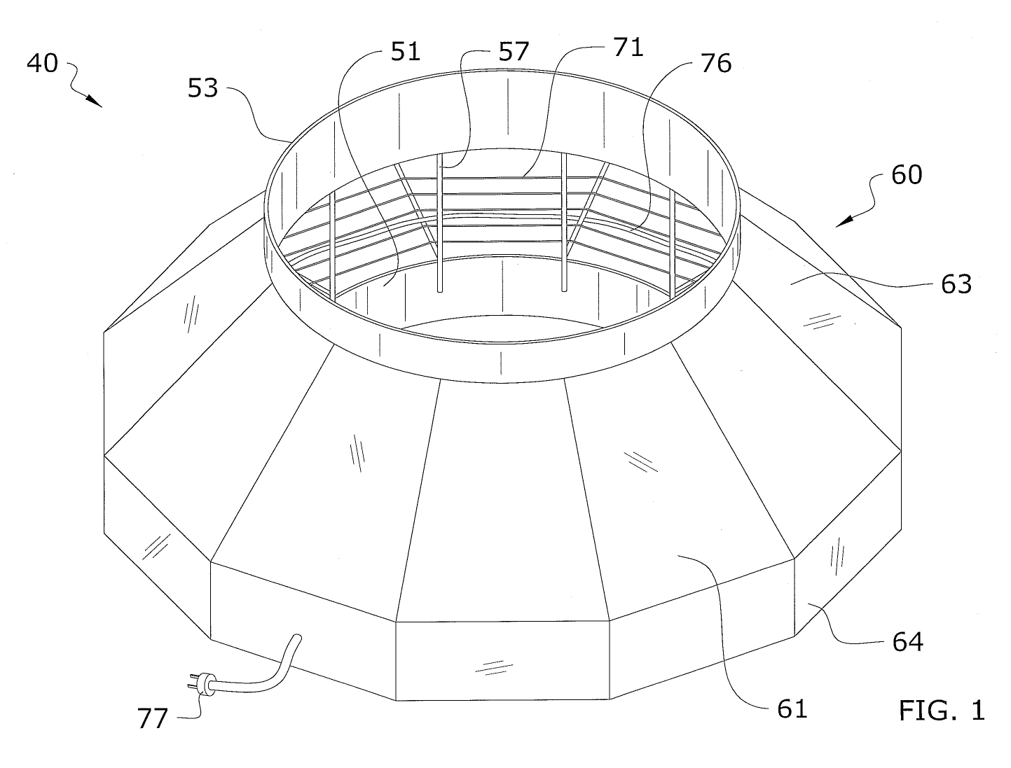

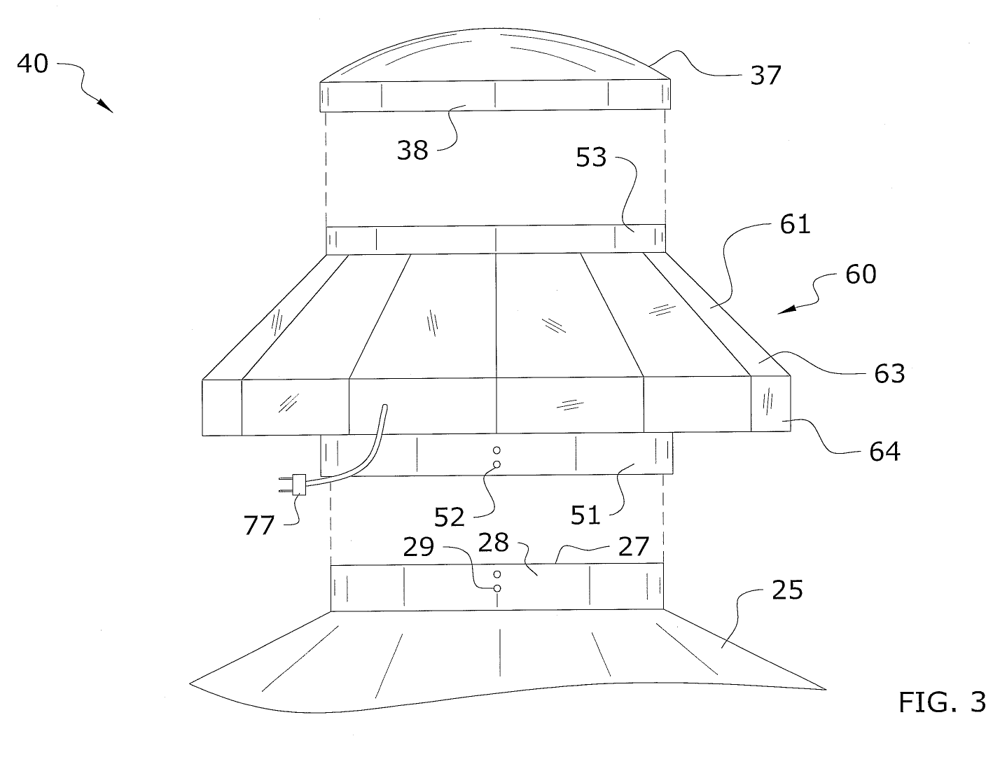

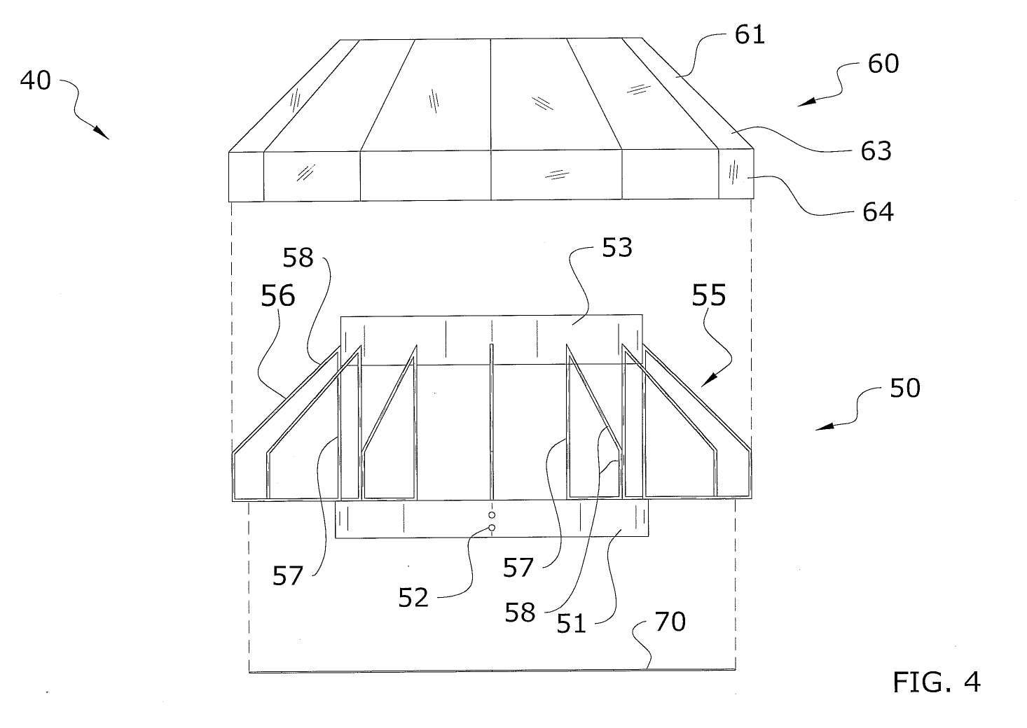

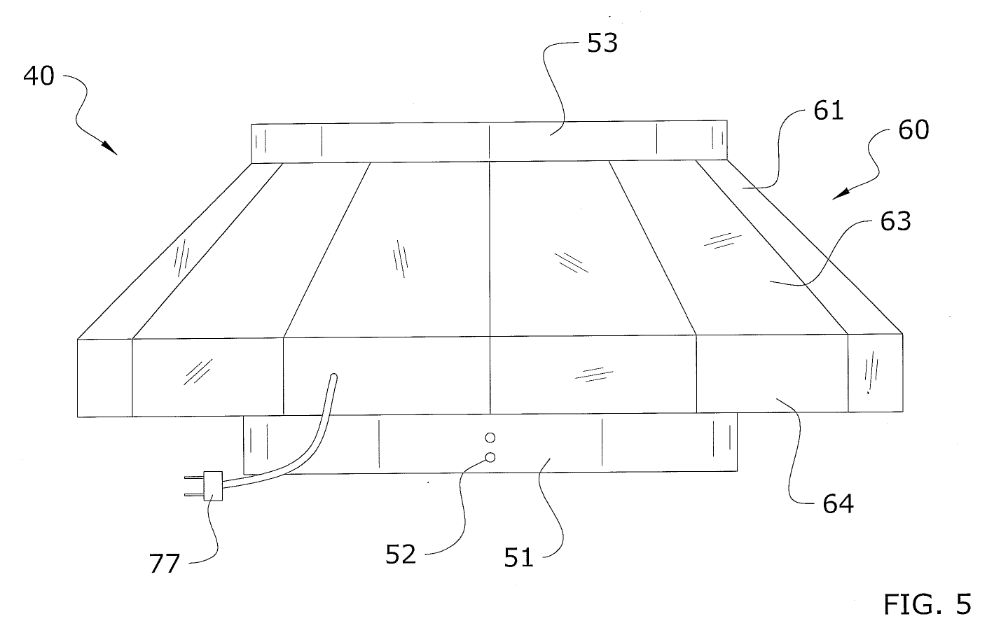

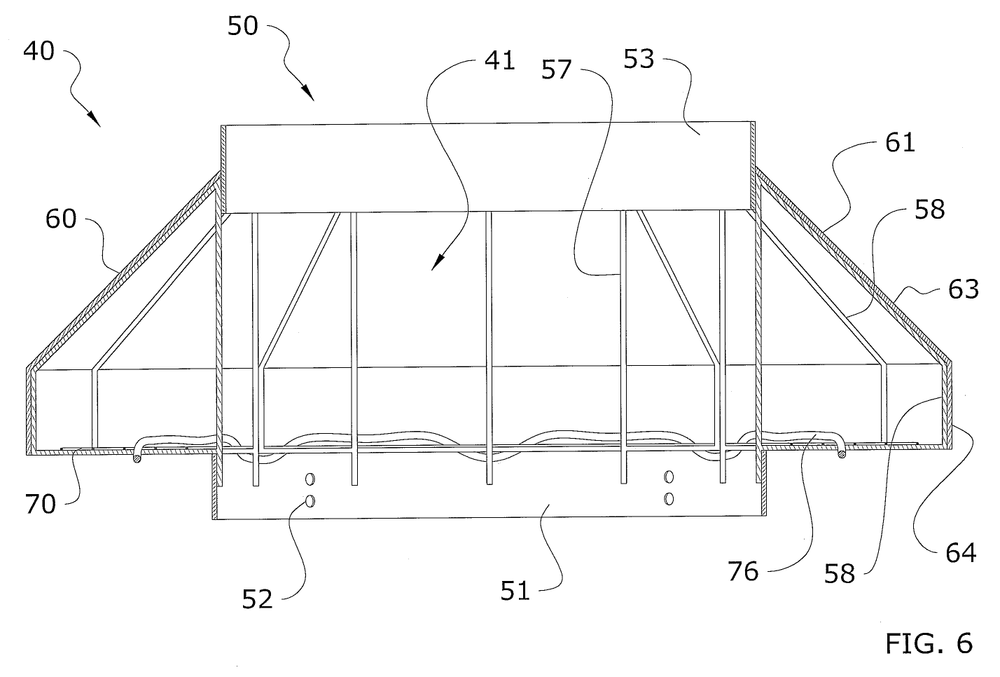

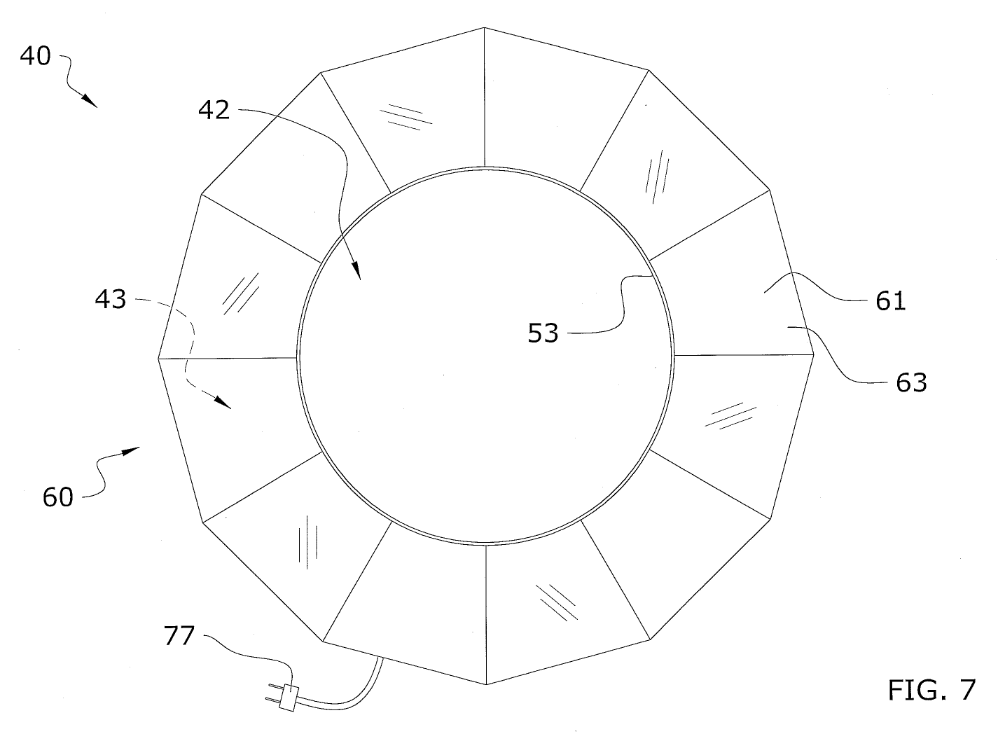

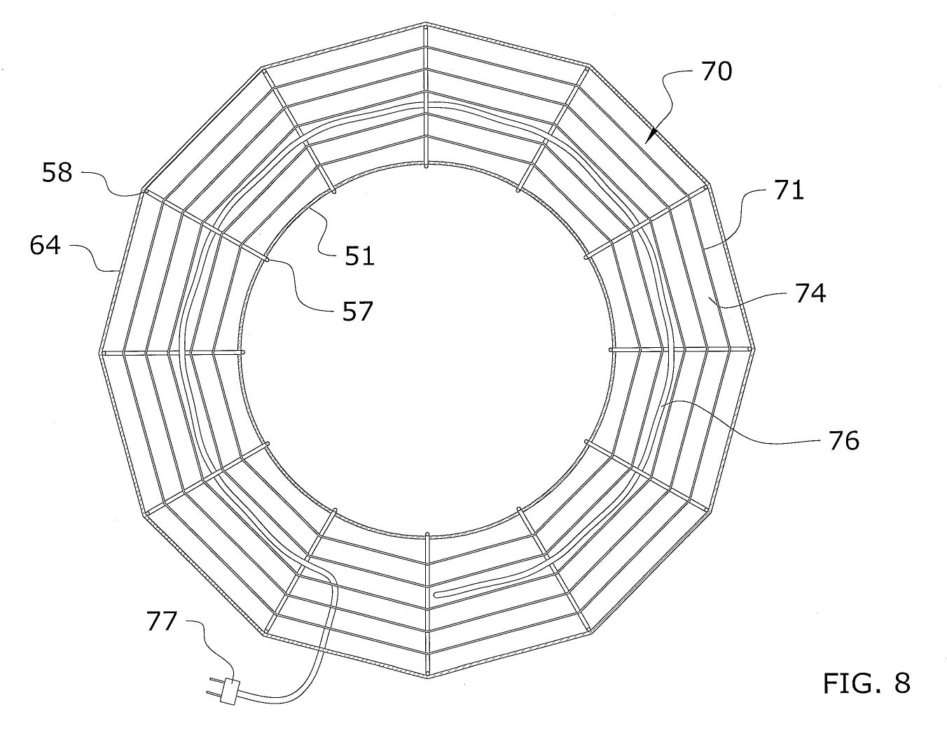

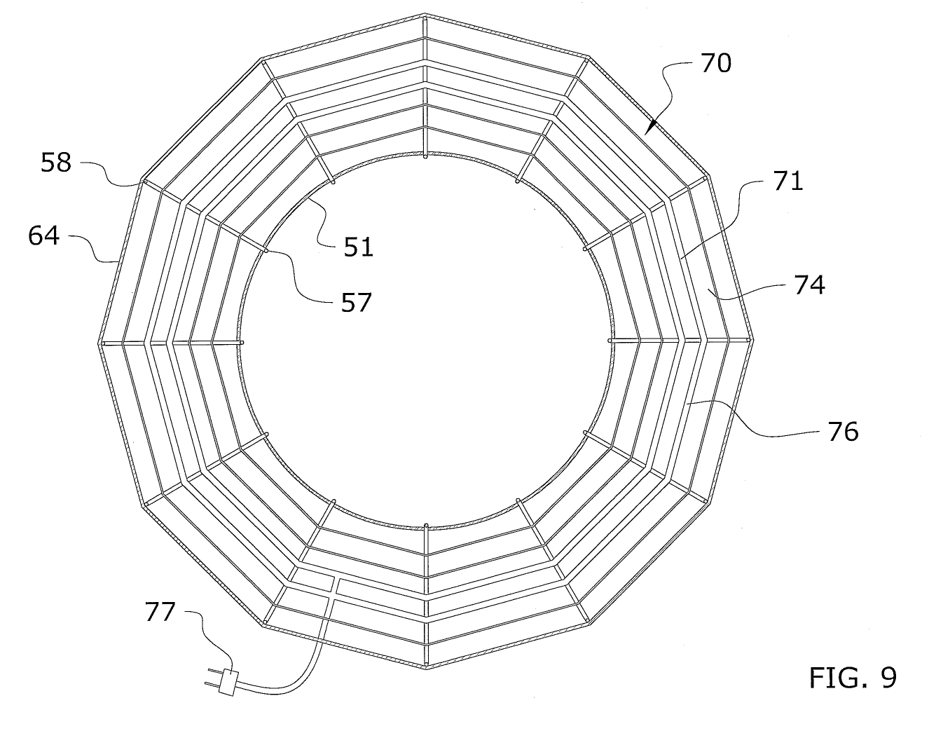

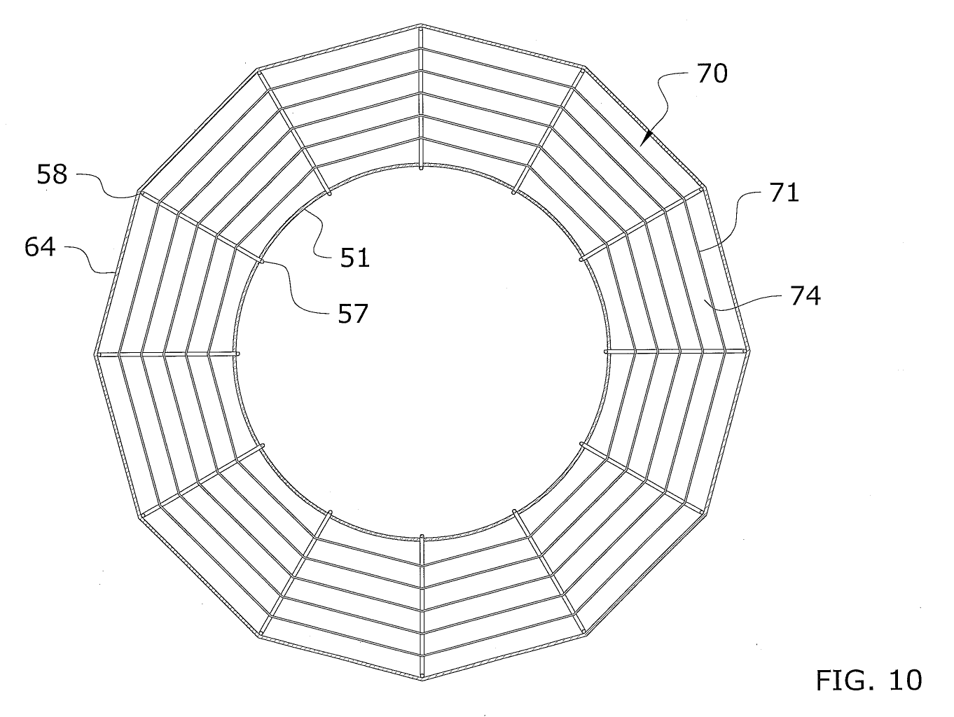

Turning now descriptively to the drawings, in which similar reference characters denote similar elements throughout the several views, FIGS. 1 through 10 illustrate a roof ventilation system 10, which comprises a frame 50 extending from the upper opening 27, wherein the frame 50 defines a passageway 41 extending through an interior of the frame 50 adapted to communicate air flow between an interior of the grain bin 20 and ambient air. A shell 60 at least partially surrounding the frame 50 to at least partially seal the interior of the frame 50. A screen 70 is interconnected between the frame 50 and the shell 60, wherein the screen 70 includes a plurality of outlets 74 extending therethrough in communication with the passageway 41. A heating element 76 is in communication with the screen 70, wherein the heating element 76 dissipates heat to the screen 70 to prevent ice buildup upon the screen 70.

### B. Grain Bin

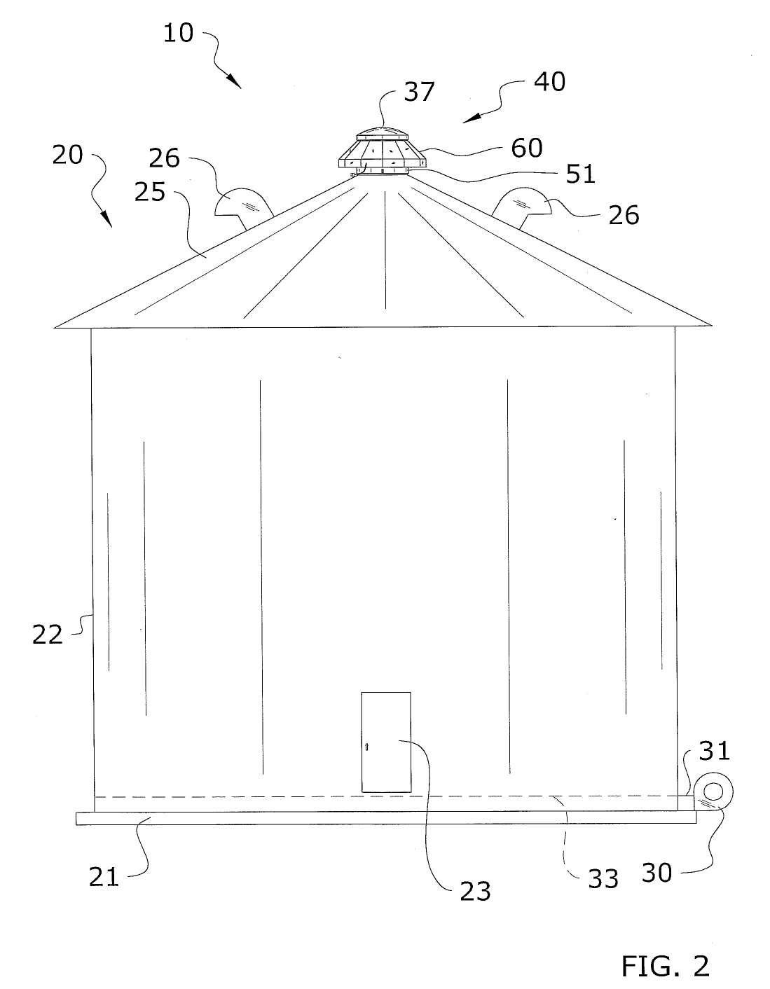

The present invention is preferably used with a grain bin 20, such as one illustrated in FIG. 2. The grain bin 20 may be used to store various types of grain or other substances or objects as desired. Further, it is appreciated that in alternate embodiments, the present invention may be used upon various other buildings or structures.

The grain bin 20 is generally includes a cylindrical body 22 formed of a multitude of sheet-metal panels which may be mounted and bolted together on a foundation 21, such as a concrete foundation 21. The body 22 may include one or more doors 23 to access the inside of the grain bin 20. A roof 25 of a generally conical shape extends from the body 22, which is also generally formed of a multitude of sheet-metal panels, only of a wedge shape. A collar 28 joins the upper end of the panels of the roof 25, wherein the collar 28 is generally comprised of a hollow circular shaped structure. An upper central opening 27 is defined by the collar 28 and extends through the peak of the roof 25.

Generally a lid 37, also including a collar 38 to connect to the collar 38 of the roof 25, sits atop the roof 25. The lid 37 may be various shapes, such as a dome shape and provides access within the grain bin 20 through the upper opening 27 extending through the roof 25. The lid 37 may be removed for an individual to climb inside, inspect, or allow air ventilation therethrough. In the present invention, the lid 37 is separated from the roof 25 via the vent structure 40 which is situated between the lid 37 and the collar 28 to provide a continually vented grain bin 20.

The grain bin 20 also includes a blower fan 30 and a heater 31 adapted to draw ambient air from the outside of the grain bin 20 into the interior of the grain bin 20. The air is heated blown through the grain to dry the grain. The fan 30 and heater 31 are preferably common in the art of grain bins 20 and may be external or internal to the grain bin 20. The heated air is generally blown below a perforated floor 33 which the grain rests upon and is blown out of the grain bin 20 through on or more vents 26 extending from the sides of the roof 25 and also through the venting structure of the cap assembly.

### C. Vent Structure

The vent structure 40 allows for the air to circulate through the grain bin 20 year round during freezing and non freezing temperatures without becoming blocked due to ice, debris, or other, yet prevents rain, snow, or other debris from entering the grain bin 20. The vent structure 40 defines a passageway 41 that is adapted to communicated air flow from the interior of the grain bin 20 and ambient air. The passageway 41 generally travels from the lower collar 51 to through the screen 70. The passageway 41 may also travel through the upper collar 53 if the lid 37 is removed. The vent structure 40 may be installed upon new grain bins 20 or may be easily retrofitted to existing grain bins 20 by being positioned between the roof collar 25 and the lid collar 37. The vent structure 40 is also generally comprised of a similar material as the grain bin 20 itself to substantially blend in with the grain bin 20 after being installed. The vent structure 40 is further hollow to allow for the passageway 41.

i. Frame

The vent structure 40 includes a frame 50 to attach the vent structure 40 to both the roof collar 25 of the grain bin 20 and the lid collar 37 of the lid 37. The frame 50 also provides the support for the vent structure 40 and support to create the passageway 41. The frame 50 includes a lower collar 51 that preferably attaches on a lower end to the roof collar 25. The lower collar 51 is comprised of a similar shape as the roof collar 25, wherein the lower collar 51 is comprised of a hollow circular shape that allows the internal air flowing through the upper opening 27 to continue to flow into the vent structure 40 through the lower collar 51.

The lower collar 51 also preferably includes a plurality of apertures 52 extending therethrough to align with apertures 29 of the roof collar 25, wherein fasteners may be extended through to fasten the lower collar 51 and thus vent structure 40 to the roof collar 25 and thus roof 25 of the grain bin 20. The frame 50 also includes the upper collar 53 which is distally spaced and concentric with both the lower collar 51 and the upper opening 27. The upper collar 53, like the lower collar 51 is comprised of a hollow ring shape.

In the preferred embodiment, the passageway 41 includes a first portion 42 and a second portion 43, wherein both are fluidly connected. The first portion 42 is vertically oriented and aligns with the lower collar 51 and the upper collar 53. When the lid 37 is removed from the upper collar 53, the air flow is able to travel directly along the first portion 42 into the vent structure 40 through the lower collar 51 and out of the vent structure 40 through the upper collar 53 to ambient air.

When the lid 37 is connected to the upper collar 53 to cover the upper collar 53, the air flow is directed to the second portion 43 which is laterally outwards of the first portion 42. The air flow then travels downward within the second portion 43 of the passageway 41 through the screen 70 to ambient air. The frame 50 includes a plurality of trusses 56 to define the second portion 43 of the passageway 41.

The plurality of trusses 56 radially extend from the perimeter of the lower collar 51 and the upper collar 53 to provide the internal support structure 55 for the vent structure 40. The internal support structure 55 may be comprised of various configurations all which provide support to the vent structure 40 to allow the vent structure 40 to maintain shape. In the preferred embodiment, the trusses 56 are used as the internal support structure 55 and generally include an inner part 57 and an outer part 58. The trusses 56 may be comprised of various structures, such as cylindrical shaped rods as illustrated in Figure X.

The inner part 57 vertically extends from the perimeter of the lower collar 51 to connect the lower collar 51 to the upper collar 53. The inner part 57 thus generally extends the height of the vent structure 40. The outer part 58 extends from the upper end of the inner part 57 at an outward slant and then in a vertical direction to define the outward shape of the vent structure 40. The lower end of the outer part 58 of the trusses 56 is preferably level with the upper end of the lower collar 51. The lower end of the outer part 58 of the trusses 56 is also preferably distally spaced from the upper end of the lower collar 51 to provide adequate space for the screen 70 to extend between thereof and connect the lower end of the outer part 58 of the trusses 56 to the upper end of the collar.

The inner part 57 and the outer part 58 of the trusses 56 define the second portion 43 of the passageway 41. The second portion 43 of the passageway 41 is concentric with the first portion 42 and is further also in a ring shape that laterally extends outward from the first portion 42. The angled outer part 58 of the trusses 56 helps to direct the interior air downward within the second portion 43 and toward the screen 70 to subsequently mix with the ambient air.

As described previously, the upper collar 53 extends vertically upward from the trusses 56 and is preferably comprised of a same diameter and shape as the roof collar 25 of the grain bin 20 to receive the lid 37 that was previously attached to the grain bin 20 prior to installation of the vent structure 40. The upper collar 53 is thus comprised of a hollow cylindrical shape and may include a plurality of apertures also for affixing the lid 37 thereto. The lower collar 51 and the lid collar 37 are comprised of the same diameter and the upper collar 53 and the roof collar 25 are preferably comprised of same diameters to allow for the vent structure 40 to easily be attached between the lid 37 and the roof collar 25 via simply slidably attaching the collars. A latch or hinge mechanism may also be used to attach the lid collar 37 and lid 37 to the upper collar 53 of the venting structure 40.

ii. Shell

The vent structure 40 also includes a shell 60 to surround a portion of the frame 50 in particular the outer part 58 of the trusses 56. The frame 50 follows the outside of each of the outer parts 58 across the slanted portion and the vertical portion of the outer parts 58. The shell 60 ensures that the internal air is only able to be released through the screen 70 or through the upper collar 53 (if the lid 37 is open). The shell 60 is generally comprised of a sheet metal structure and includes a plurality of segments 61 forming a conical shaped structure similar to the peak of the roof 25.

The shell 60 is layered over the outside of the outer part 58 of the trusses 56 as shown in Figure X. The use of the shell 60 ensures that no birds, other animals, debris, rain, snow, etc., is able to enter within the vent structure 40. It is appreciated that the shell 60 may be comprised of multiple segments 61 attached to each other or may be comprised of a single piece of material formed around the trusses 56.

In the preferred embodiment, the shell 60 includes an upper portion 63 and a lower portion 64 extending from the upper portion 63. The upper portion 63 slants outward and follows an orientation of the slanted portion of the outer part 58 of the trusses 56. The lower portion 64 is vertically oriented and follows an orientation of the vertical portion of the outer part 58 of the trusses 56. It is appreciated that the upper portion 63 and the lower portion 64 are preferably integrally formed.

iii. Screen and Heating Element

The vent structure 40 also includes the screen 70 which may optionally include a heating element 76. The screen 70 is horizontally oriented in a ring shape and preferably extends between the lower end of the outer part 58 of the trusses 56 and the upper end of the lower collar 51. The screen 70 is thus extends laterally outward from the lower collar 51, wherein the inner most diameter of the screen 70 is substantially similar to the outer most diameter of the lower collar 51. The screen 70 is further concentric with the upper opening 27 of the grain bin 20, the lower collar 51 and the upper collar 53 and is positioned laterally outward of the upper opening 27 of the grain bin 20, the lower collar 51 and the upper collar 53.

In the preferred embodiment, the screen 70 includes a grid 71. The grid 71 defines a plurality of evenly spaced outlets 74 extending therethrough for allowing the internal air flowing through the vent structure 40 from the grain to be released into the ambient air external of the grain bin 20. The grid 71 is shaped to provide for multiple small outlets 74 so as to allow a least amount of restriction as possible. The grid 71 may be comprised of wire, rods, or various other structures all which restrict animals, such as birds, squirrels, etc., and debris from entering the vent structure 40 through the outlets 74, yet allow air and moisture to be released from the vent structure 40 into the ambient air. In the preferred embodiment, the grid 71 forms a crisscross structure or interlocking elements to form square or other shaped outlets 74; however various types of grids 71 may be used with the screen 70 as appreciated.

The screen 70 also preferably includes a heating element 76 for heating the grid 71 to prevent ice buildup from the moisture being exposed to the cold ambient air during cold periods of the year. In one embodiment, the heating element 76 is comprised of a heating wire or a heat tape that is interlaced with the grid 71 and travels around a central or otherwise located perimeter of the screen 70. The heating element 76 thus includes an electrical plug 77 which may be electrically connected to provide power thereto when needed (during cold periods of the year). The heating element 76 is preferably interconnected with the screen 70; however it is appreciated that the heating element 76 may be separate from the screen 70 yet directed toward the screen 70 to have the same effect.

In another embodiment, the heating element 76 may be integral with the grid 71, wherein the grid 71 would be able to be electrically powered so that heat dissipates from the grid 71. The plug 77 would thus be electrically connected to the grid 71 so as to provide direct electrical power for producing heat to the grid 71. Various alternate embodiments of the heating element 76 may be used all of which heat the grid 71 to prevent ice buildup from the moisture travelling within the internal air of the grain bin 20 that is to be released into the ambient air.

The heating element 76 may be turned on and off as necessary and generally does not need to be turned on during above freezing periods of the year. The heating element 76 may be manually turned on and off by plugging or unplugging the electrical plug 77 of the heating element 76 to a mating electrical socket. The heating element 76 may also be programmed to turn on and off via a temperature controller that automatically turns the heating element 76 on when the temperature falls below freezing.

The heating element 76 may also be turned on and off according to the calendar date, such as turned on in November and turned off in May. Various other manners of controlling the heating element 76 may be used as appreciated. It is also appreciated that turning the heater 31 on may refer to sending electrical current through the heating element 76 to dissipate heat or any other manner in which heat may be dissipated from the heating element 76 and transferred to the grid 71. Contrarily, turning the heating element 76 off refers to the interrupting the electrical current or heat going to the heating element 76 and grid 71. It is appreciated that in an alternate embodiment, the heating element 76 may be omitted, such as for use in warmer climates.

### D. Operation of Preferred Embodiment

In use, the vent structure 40 is installed on a lower end to the roof collar 25 and the existing lid 37 of the grain bin 20 is secured to the upper collar 53. During freezing temperatures, the heating element 76 is activated to dissipate heat from electrical current to the grid 71. The intake fan 30 brings in ambient air, which is subsequently heated via the heater 31. The heated air, which is now internal to the grain bin 20, is circulated through the grain via flowing through a perforated floor 33 that the grain rests upon.

The internal air containing the moisture collected from the grain is then directed to the upper opening 27 and through the vent structure 40, where the internal air travels through the openings of the screen 70. The heating element 76 is continually heating the grid 71 during this process to ensure that no moisture from the internal air or ambient air is able to freeze upon the grid 71 thus keeping the openings clear for air passage.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A vent for covering an upper opening of a grain bin, comprising:
a frame extending from said upper opening, wherein said frame defines a passageway extending through an interior of said frame;
wherein said passageway is adapted to communicate air flow between an interior of said grain bin and ambient air;
a shell at least partially surrounding said frame to at least partially seal said interior of said frame;
a screen interconnected between said frame and said shell, wherein said screen includes a plurality of outlets extending therethrough and wherein said plurality of outlets are in communication with said passageway; and
a heating element in communication with said screen, wherein said heating element dissipates heat to said screen to prevent ice buildup upon said screen.

2. The vent of claim 1, wherein said screen is comprised of a ring shape.

3. The vent of claim 1, wherein said screen is oriented horizontally.

4. The vent of claim 1, wherein said shell extends over an upper surface of said screen.

5. The vent of claim 1, wherein said heating element is comprised of a heating tape interlaced with said screen.

6. The vent of claim 1, wherein said heating element is comprised of a heating wire interlaced with said screen.

7. The vent of claim 1, wherein said heating element is comprised of a grid, wherein said grid forms said plurality of outlets.

8. The vent of claim 1, wherein said heating element includes an electrical plug for directing electrical current through said heating element.

9. The vent of claim 1, wherein said frame includes a lower collar for connecting to roof collar of said grain bin and an upper collar for connecting to a lid collar of a lid.

10. The vent of claim 9, wherein said frame includes an internal support structure, wherein said internal support structure connects said lower collar to said upper collar.

11. The vent of claim 10, wherein said internal support structure includes a plurality of trusses radially extending from a perimeter of said lower collar and said upper collar.

12. The vent of claim 11, wherein said plurality of trusses each include an inner part and an outer part, wherein said inner part is vertically oriented and wherein said outer part angles outward.

13. The vent of claim 12, wherein said screen is connected between said inner part and said outer part of each of said plurality of trusses.

14. A vent for covering an upper opening of a grain bin, comprising:
a frame including a lower collar and an upper collar, wherein said lower collar connects to said grain bin in fluid communication with said upper opening;
wherein said frame includes a plurality of trusses connecting said lower collar to said upper collar;
wherein said plurality of trusses radially extend from a perimeter of said lower collar and said upper collar;
wherein said plurality of trusses each include an inner part and an outer part, wherein said inner part is vertically oriented and wherein said outer part angles outward;
wherein said frame defines a passageway extending through an interior of said frame;
wherein said passageway is adapted to communicate air flow between an interior of said grain bin and ambient air;
a shell connected an outside of said outer part of each of said plurality of trusses, wherein said shell surrounds said plurality of trusses;
a screen interconnected between said inner part and said outer part of each of said plurality of trusses;
wherein said screen includes a plurality of outlets extending therethrough and wherein said plurality of outlets are in communication with said passageway; and
a lid movably connected to said upper collar to cover said upper collar.

15. The vent of claim 14, wherein said screen is concentric with said lower collar.

16. The vent of claim 14, wherein said screen is positioned laterally outwards with respect to said lower collar.

17. The vent of claim 14, wherein said screen is comprised of a horizontally oriented ring shape.

18. The vent of claim 14, wherein said passageway includes a first portion and a second portion, wherein said second portion is concentric with said first portion, wherein said first portion is aligned with said lower collar and said upper collar and wherein said second portion is directed laterally outwards from said first portion between said inner part and said outer part of each of said plurality of trusses.

19. The vent of claim 18, wherein said screen is in direct communication with said second portion.

20. A vent for covering an upper opening at the peak of a grain bin, comprising:
a frame including a lower collar and an upper collar, wherein said lower collar connects to said grain bin in fluid communication with said upper opening;
wherein said frame includes a plurality of trusses connecting said lower collar to said upper collar;
wherein said plurality of trusses radially extend from a perimeter of said lower collar and said upper collar;
wherein said plurality of trusses each include an inner part and an outer part, wherein said inner part is vertically oriented and wherein said outer part angles outward;
wherein said frame defines a passageway extending through an interior of said frame;
wherein said passageway is adapted to communicate air flow between an interior of said grain bin and ambient air;
a shell connected an outside of said outer part of each of said plurality of trusses, wherein said shell surrounds said plurality of trusses;
a screen interconnected between said inner part and said outer part of each of said plurality of trusses;
wherein said screen includes a plurality of outlets extending therethrough and wherein said plurality of outlets are in communication with said passageway;
a heating element in communication with said screen, wherein said heating element dissipates heat to said screen to prevent ice buildup upon said screen;
wherein said screen is comprised of a ring shape;
wherein said screen is oriented horizontally;
wherein said heating element includes an electrical plug for directing electrical current through said heating element;
wherein said screen is concentric with said lower collar;
wherein said screen is positioned laterally outwards with respect to said lower collar;
wherein said passageway includes a first portion and a second portion, wherein said second portion is concentric with said first portion;
wherein said first portion is aligned with said lower collar and said upper collar;
wherein said second portion is directed laterally outwards from said first portion between said inner part and said outer part of each of said plurality of trusses;
wherein said screen is in direct communication with said second portion; and
a lid movably connected to said upper collar to cover said upper collar.
